(19) United States
(12) Patent Application Publication
(10) Pub. No.: US 2014/0286449 A1
(43) Pub. Date: Sep. 25, 2014

(54) WIRELESS LINK APPARATUS

(71) Applicant: Electronics and Telecommunications Research Institute, Daejeon (KR)

(72) Inventors: Kwang Seon KIM, Daejeon (KR); Min Soo KANG, Daejeon (KR); Bong-Su KIM, Daejeon (KR); Woo Jin BYUN, Daejeon (KR)

(73) Assignee: Electronics and Telecommunications Research Institute, Daejeon (KR)

(21) Appl. No.: 13/922,819

(22) Filed: Jun. 20, 2013

(30) Foreign Application Priority Data
Mar. 22, 2013 (KR) 10-2013-0030883

(51) Int. Cl. H04B 7/04

(52) U.S. Cl. CPC H04B 7/0404
USPC 375/267

(57) ABSTRACT

A wireless link apparatus includes a plurality of antennas; a signal detector configured to calculate SNR based on a signal received from at least one of the plurality of antennas; and a mode selector configured to determine the number of an antenna to be used in modulation method and signal transmission by comparing the calculated SNR with a preset critical value. Further, the wireless link apparatus includes a transmitter configured to modulate a signal in the modulation method determined by the mode selector and transmit the modulated signal using an antenna corresponding to the determined number of the antennas.

### CROSS-REFERENCE TO RELATED APPLICATIONS

The present invention claims priority of Korean Patent Application No. 10-2013-0030883, filed on Mar. 22, 2013, which is incorporated herein by reference.

### FIELD OF THE INVENTION

The present invention relates to a fixed Line-Of-Sight (LOS) wireless link apparatus using high frequency, and more particularly, to a wireless link apparatus for transmitting a preset quantity of data at high rate regardless of environment such as weather.

### BACKGROUND OF THE INVENTION

Conventional wireless network markets need a high-speed backhaul network to maintain a large capacity/high speed communication network as various high-speed wireless data services such as 4G mobile communications, 802.11n/ac, wireless LAN, etc., are developed.

Moreover, for explosive increase of data in a cell, small cell-centered configurations are increased to solve the problem of the explosive increased quantity of data. To support these network architectures, demands for wireless networks to connect conventional cell stations are increasing.

Several frequency bands are used in a fixed wireless network for the small cells, particularly a frequency band higher than 10 GHz and a high order modulation higher than 16 QAM are used for a large transmission of several hundred megabits (MBs).

In a fixed wireless network higher than 10 GHz, the LOS region is mainly used to configure a stable link. In general, the link connection property is strongly influenced by rainfall attenuation rather than fading of environment.

To overcome the rainfall attenuation, a method of determining an output power and a transmission range from allowable maximum raining condition is widely used. Since a wide frequency band can be used as usable frequency band comes higher, it is advantageous to transmit data at high speed. However, since the rainfall attenuation increases as frequency is higher, the transmission range is shortened.

In order to overcome the drawbacks of shortened transmission range, methods of switching a system to a low frequency band to transmit data or changing modulation method or error coding to be operated at low signal noise ratio (SNR) are used.

Hereinafter, the existing wireless transmission system will be described with reference to the accompanying drawings.

FIG. 1 is a view illustrating drawbacks of a large capacity fixed wireless system applied to an exemplary embodiment of the present invention.

As illustrated in FIG. 1, a large capacity fixed wireless system with a frequency band higher than 10 GHz uses the LOS link while the most important loss of link budget is due to the rainfall. The loss caused by rainfall increases rapidly as frequency comes higher and gradually increases near about 100 GHz.

The loss caused by rainfall leads to reduce SNR in the same transmission range because of attenuation of signals. There are used two methods in order to overcome the reduced SNR. One of the methods, as illustrated in FIG. 2, is to change modulation and error rate of signals according to preset SNR. In a system employing this method, input data is modulated into signals and is up-converted after passing through a transmitter, then in a test-driven development (TDD) system, the converted signal is radiated through an antenna via a switch. A signal received through an antenna is down-converted via a receiver and is restored into data by signal demodulation. In this case, a received signal strength indication (RSSI) detector determines strength of a signal and a modulation controller determines a proper modulation index to control a transceiver MODEM. This method has a simple structure but low transmission rate.

The other is, as illustrated in FIG. 3, to transmit data using a frequency band of a small loss caused by rainfall. That is, input data is modulated and passes through a path switch to a low band transmitter or a high band transmitter selectively, then is radiated through respective antennas. A signal received through an antenna passes through a low band receiver or a high band receiver to be selected by a path switch and is restored into proper data by signal demodulation. The RSSI detector determines strength of the received signal to select a proper path. This method, as illustrated in FIG. 2, needs many additional blocks and has a complicated structure.

Meanwhile, the rainfall loss may be generated not only on a path but by increase of fading component. That is, fading components may increase due to variation of atmospheric refraction property caused by nonuniform rainfall density and electromagnetic wave reflection property caused by water layer formed on outer walls of buildings due to rain in a region where rain falls.

### SUMMARY OF THE INVENTION

In view of the above, the present invention provides a wireless transmission apparatus for employing a high order digital modulation on clean days while employing low order modulation according to the amount of rainfall on rainy days and for employing antenna transmission for spatial modulation so that transmission range and rate can be guaranteed.

In accordance with an embodiment of the present invention, there is provided a wireless link apparatus including: a plurality of antennas; a signal detector configured to calculate SNR based on a signal received from at least one of the plurality of antennas; a mode selector configured to determine the number of an antenna to be used in modulation method and signal transmission by comparing the calculated SNR with a preset critical value; and a transmitter configured to modulate a signal in the modulation method determined by the mode selector and transmit the modulated signal using an antenna corresponding to the determined number of the antennas.

Further, the wireless link apparatus may further comprise a sensor configured to detect rain attenuation, and the mode selector may determine modulation method and the number of antennas based on the SNR and the rain attenuation.

Further, the mode selector may select QPSK or BPSK modulation and at least two of the plurality of antennas when the SNR is less than 20 or the rain attenuation is equal to or higher than 20 dB.

Further, the wireless link apparatus may further comprise a switching controller switched such that antennas corresponding to the number of antennas are connected to the transmitter.

Further, the transmitter may comprise a serial-parallel (S/P) converter configured to perform serial-parallel conversion of an input signal; a signal modulator configured to modulate the converted signal according to the modulation method; a transmitter unit configured to perform up-conversion of frequency of the modulated signal; and an antenna modulator configured to select one of the plurality of transmission coding patterns according to the number of antennas and provide the selected transmission coding pattern to the switching controller. Here, the antenna modulator may have a plurality of transmission coding patterns to select an antenna for transmission from the plurality of antennas.

Further, the number of transmission coding patterns may be determined based on the number of the antennas.

Further, the mode selector may control a modulation method of a receiver of the wireless link apparatus and an antenna modulation method using the selected modulation method.

In accordance with the present invention, in a fixed point-to-point and a point-to-multipoint LOS wireless link apparatus using high frequency, not high order digital modulation but other modulation is used in order to overcome low SNR due to rain attenuation and data is transmitted using a plurality of antennas, so that data can be transmitted at a preset high transmission rate regardless of weather change.

Moreover, due to maintenance of a stable wireless link, use of a simple transceiver configuration can obtain availability approximate to that of lined link.

### BRIEF DESCRIPTION OF THE DRAWINGS

The objects and features of the present invention will become apparent from the following description of embodiments given in conjunction with the accompanying drawings, in which:

FIG. 1 is a diagram illustrating drawbacks of a large capacity fixed wireless system applied to an exemplary embodiment of the present invention;

FIGS. 2 and 3 are block diagrams illustrating a transceiver to overcome the SNR loss in the related art; and

FIG. 4 is a block diagram illustrating a wireless link apparatus according to an exemplary embodiment of the present invention.

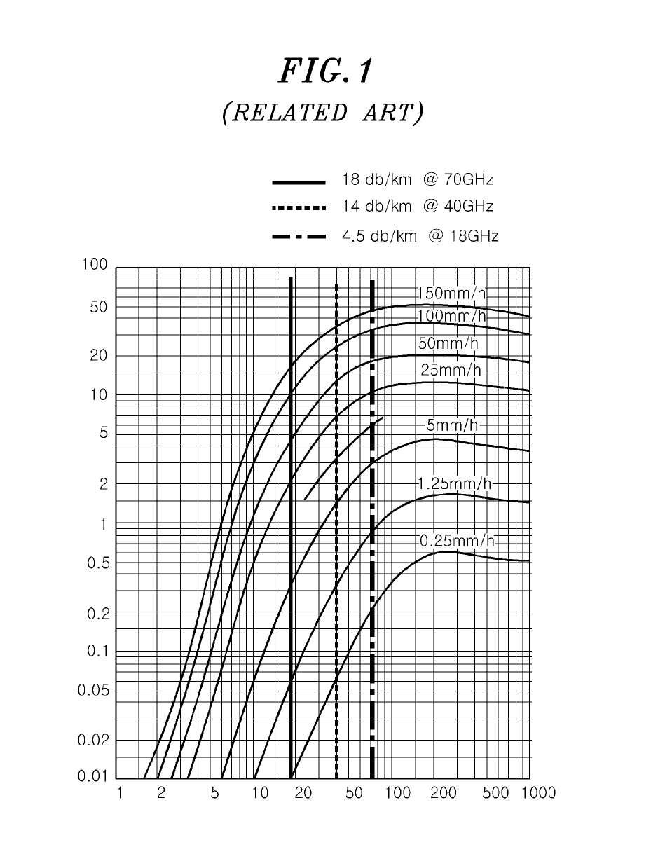

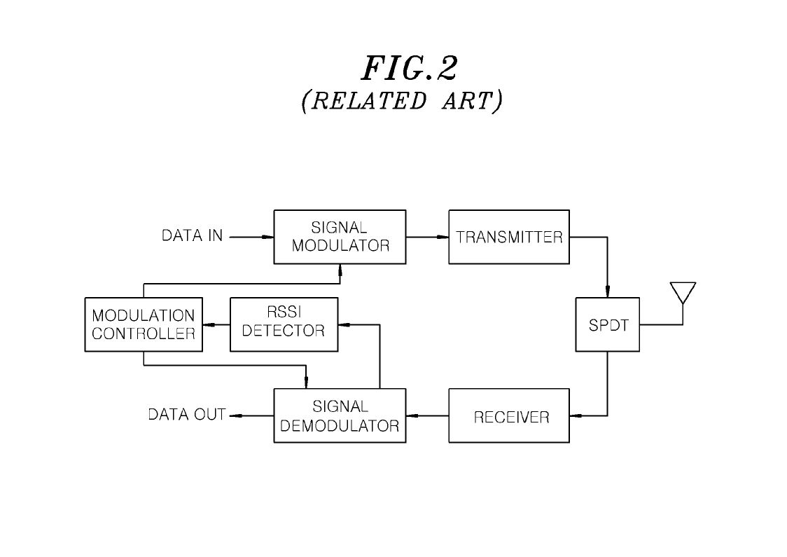

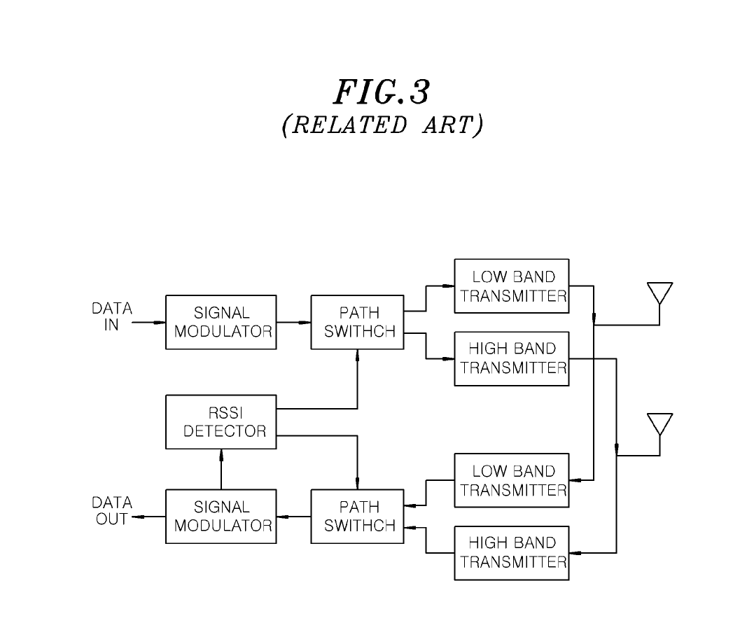

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Hereinafter, embodiments of the present invention will be described with reference to the accompanying drawings.

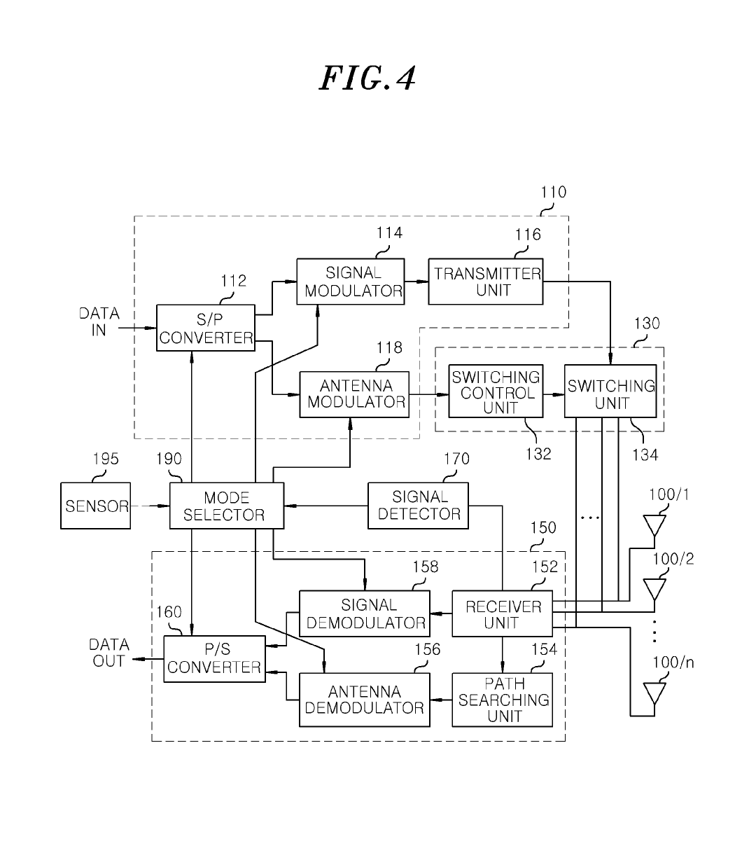

FIG. 4 is a block diagram illustrating a wireless link apparatus according to an exemplary embodiment of the present invention.

The wireless link apparatus as illustrated in FIG. 4 may include a plurality of antennas 100/1, 100/2 . . . , 100/n, a transmitter 110, a switching controller 130, a receiver 150, a signal detector 170, and a mode selector 190.

The transmitter 110 may include a serial-to-parallel (S/P) converter 112 performing serial-parallel conversion of input data, a modulator 114 modulating the converted input data, a transmitter unit 116 up-converting frequency of modulated signals to transmit the signals through antennas connected to the control of a switching controller 130, and an antenna modulator 118 controlling the switching controller 130 based on the converted input data.

In an exemplary embodiment of the present invention, the modulator 114 and the antenna modulator 118 may perform modulation in different ways based on an index determined by the mode selector 190. That is, in a case where modulations are set based on indices as listed in following Table 1, when an index 1 is determined by the mode selector 190, the modulator 114 modulates input data converted in 16 quadrature amplitude modulation (QAM) and the antenna modulator 118 controls the switching controller 130 such that one antenna, for example the antenna 100/1 is selected.

TABLE 1

| | Index 1 | Index 2 | Index 3 |
|---|---|---|---|
| Rainfall attenuation | 0 dB | 10 dB | 15 dB |
| Critical value of SNR | 0 | 10 | 5 |
| Modulation | 16QAM | QPSK | BPSK |
| Antenna modulation | 0 | 2 | 3 |
| No. of antennas | 1 | 4 | 4 (single + dual) |
| Quantity of transmission | 4 bps/Hz | 4 bps/hz | 4 bps/Hz |

The above Table 1 shows an example of transmission method of minimizing loss caused by rainfall using four antennas. As listed in Table 1, it can be understood that use of four antennas guarantees the same transmission rate even though there is loss caused by a predetermined quantity of rainfall. That is, it can be understood that total throughput as transmission rate of data per unit time is constant.

The switching controller 130 may include a switching control unit 132 and a switching unit 134. In this case, the switching control unit 132 applies a switching control signal to allow the antenna modulator 118 to select an antenna according to a preset coding method to the switching unit 134 while the switching unit 134 may connect at least one of the plurality of antennas 100/1, 100/2, . . . , and 100/n to the transmitter unit 116 based on the switching control signal. By doing so, the signal up-converted by the transmitter unit 116 may be transmitted through an antenna connected to the switching unit 134.

Meanwhile, the switching unit 134 may be implemented with a switch matrix and by doing so a plurality of antennas may be selected. In this case, the antenna modulator 118 may control the switching control unit 132 using various transmission code patterns. For example, an antenna may be selected by using eight transmission code patterns in a case when using four antennas and information to select an antenna using sixteen transmission code patterns may be supplied to the switching control unit 132 in a case of a polarized antenna.

The receiver 150 may receive a signal via a plurality of paths. The receiver 150 may include a receiver unit 152 receiving signals through the plurality of antennas 100/1, 100/2, . . . , and 100/n, a path searching unit 154 estimating a channel using the signals received by the receiver unit 152 and searching for the number of an antenna through which the signals are received via the estimated channel, an antenna demodulator 156 modulating the signals based on the number of the antenna according to a designated coding method, a signal demodulator 158 demodulating the signals received by the receiver unit 152, and a parallel-serial (P/S) converter 160 performing parallel-serial conversion of the signals demodulated by the signal demodulator 158.

The signal detector 170 calculates SNR using the signals received by the receiver unit 152 and supplies the calculated SNR to the mode selector 190.

The mode selector 190 selects an index to determine the antenna modulation and demodulation or the signal modulation and demodulation based on the SNR and may control the modulator 114, the antenna modulator 118, the antenna demodulator 156, and the demodulator 158 of the transmitter 110 based on the selected index.

Further, the mode selector 190 may be provided with SNR and rainfall information in association with an external sensor 195 and select the index by applying the rainfall information.

Process of transmitting signals performed by the wireless link apparatus having the above-described configuration will be described as follows.

The mode selector 190 has a table in which the rain attenuation on indices, a critical value of SNR, different signal modulations, information about antenna modulation, and the number of antennas are preset like in Table 1.

After that, the signal detector 170 detects a signal received by the receiver 150, calculates the SNR, and provides the same to the mode selector 190. By doing so, the mode selector 190 selects an index from the lookup table based on the SNR and the critical value of SNR that are provided from the signal detector 170. For example, the mode selector 190 selects an index 2 when SNR of the signal detected by the signal detector 170 is 10 and controls the signal modulator 114 and the signal demodulator 158 to modulate and demodulate the signal in QPSK signal modulation based on the selected index 2 and the antenna modulator 118 and the antenna demodulator 156 to select two antennas.

Thus, the signal modulator 114 modulates the converted data outputted from the S/P converter 112 in QPSK modulation to provide the same to the transmitter unit 116 and the transmitter unit 116 performs the up-conversion of frequency of the modulated data and provides the converted data to the switching unit 134.

Meanwhile, the antenna modulator 118 controls the switching control unit 132 to select two antennas and the switching control unit 132 applies a switching control signal to the switching unit 134 such that two of the plurality of antennas 100/1, 100/2, . . . , and 100/n are selected. By doing so, the switching unit 134 is connected to the two antennas and the transmitter unit 116 transmits the up-converted data via the connected antennas.

Although an example of using only SNR has been described in the exemplary embodiment of the present invention, the mode selector 190 may select the index based on the information received from the sensor 195 and the SNR received from signal detector 170 when information about rainfall or rain attenuation is received from the sensor 195 installed outside or inside.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A wireless link apparatus comprising:
a plurality of antennas;
a signal detector configured to calculate SNR based on a signal received from at least one of the plurality of antennas;
a mode selector configured to determine the number of an antenna to be used in modulation method and signal transmission by comparing the calculated SNR with a preset critical value; and
a transmitter configured to modulate a signal in the modulation method determined by the mode selector and transmit the modulated signal using an antenna corresponding to the determined number of the antennas.

2. The wireless link apparatus of claim 1, further comprising a sensor configured to detect rain attenuation,
wherein the mode selector determines modulation method and the number of antennas based on the SNR and the rain attenuation.

3. The wireless link apparatus of claim 2, wherein the mode selector selects QPSK or BPSK modulation and at least two of the plurality of antennas when the SNR is less than 20 or the rain attenuation is equal to or higher than 20 dB.

4. The wireless link apparatus of claim 1, further comprising a switching controller switched such that antennas corresponding to the number of antennas are connected to the transmitter.

5. The wireless link apparatus of claim 4, wherein the transmitter comprises:
a serial-parallel (S/P) converter configured to perform serial-parallel conversion of an input signal;
a signal modulator configured to modulate the converted signal according to the modulation method;
a transmitter unit configured to perform up-conversion of frequency of the modulated signal; and
an antenna modulator configured to select one of the plurality of transmission coding patterns according to the number of antennas and provide the selected transmission coding pattern to the switching controller,
wherein the antenna modulator has a plurality of transmission coding patterns to select an antenna for transmission from the plurality of antennas.

6. The wireless link apparatus of claim 5, wherein the number of transmission coding patterns is determined based on the number of the antennas.

7. The wireless link apparatus of claim 1, wherein the mode selector controls a modulation method of a receiver of the wireless link apparatus and an antenna modulation method using the selected modulation method.
